(19) United States
(12) Patent Application Publication
(10) Pub. No.: US 2003/0124333 A1
(43) Pub. Date: Jul. 3, 2003

(54) Interior material for automobile

(76) Inventor: Hiroshi Itaba, Osaka (JP)

Correspondence Address: BAYER POLYMERS LLC, 100 BAYER ROAD, PITTSBURGH, PA, 15205, US

(21) Appl. No.: 10/319,209

(22) Filed: Dec. 13, 2002

(30) Foreign Application Priority Data
Dec. 25, 2001 (JP) 2001-391070

(51) Int. Cl. B32B 27/12; B32B 3/26; B32B 5/18; B32B 5/24

(52) U.S. Cl. 428/304.4; 442/286; 442/370

(57) ABSTRACT

An automobile interior material having no irritation to skin and easy combustibility for disposal which is composed of a urethane foam layer and a fabric which is attached to at least one main surface of the urethane foam layer.

### BACKGROUND OF THE INVENTION

The present invention relates to a light-weight, high-rigidity polyurethane/polyurea automobile interior material, particularly a car headliner, having excellent recyclability which material is made without glass.

Until now, most reinforcing materials used for a surface material in a sandwich structure are glass mats. However, it is strongly desired to replace the glass mat, because the glass leaves ash due to its incombustibility when the glass mat is treated after usage thereof, for example, when energy is recovered by combustion. A natural fiber mat, a natural fiber, paper and the like are used as a partial replacement material, but these materials are not promising as complete replacement materials for glass since they have low rigidity and large weight.

The technology for shaping an article by immersing an isocyanate into a flexible urethane foam and/or a rigid urethane foam, then adding water and a urethane catalyst with both sides being reinforced with glass mats is disclosed in JP-B-63-7577, “Method of preparing a light-weight rigid or semi-rigid composite panel”. Sandwiching and thermoforming an open-cell cold-moldable polyurethane foam between two glass mats to which an adhesive is applied is disclosed in JP-A-04-211416, “Method of producing open-cell cold-moldable rigid polyurethane foam and its use for preparing a shaped article”. Each of these techniques and other similar techniques have been proposed as technology suitable for production of car headliner sandwich structure. However, all of these techniques use glass fiber as the reinforcing material. The glass fiber has an excellent reinforcement effect, but the glass fiber has the problems that the glass fiber is relatively expensive, that the glass fiber is an irritant to the skin of a worker, and that the glass leaves ash due to incombustibility when energy is recovered by combustion during disposal.

A car headliner made with a woven fabric prepared by weaving the twisted yarns of hemp fiber (for example, a Hessian cloth having a size of 10 according to JIS (Japanese Industrial Standard)) instead of the glass fiber is commercially available. This fabric called “jute cloth” is a fabric having a basis weight of 150 g/m² to 300 g/m² in which a yarn of hemp (thickness: 1 mm to 3 mm) is woven in such relatively rough texture that a separation distance between an edge of one yarn and an adjacent edge of a neighboryarn is from 2 mm to 4 mm. Since this interior material is resistant to stretch and shrink, a crease is caused at the position of a drawn part. Since it is difficult for the adhesive to penetrate into the twisted yarn, hardening is insufficient so that unevenness is easily caused on the fabric surface. Additionally, since the net texture is rough and gaps are large, a sufficient reinforcement effect is not exhibited and rigidity is low.

### SUMMARY OF THE INVENTION

An object of the present invention is to provide an automobile interior material, causing essentially no irritation to skin and that is easily combustible for disposal. Another object of the present invention is to provide an automobile interior material having easy recyclability, a low density and a light weight, without using a glass fiber as the reinforcing material for the surface material giving the sandwich structure.

The present invention which provides such an automobile interior material is composed of a urethane foam layer and a fabric which is attached to at least one main surface of the urethane foam layer.

### DETAILED DESCRIPTION OF THE PRESENT INVENTION

The automobile interior material of the present invention is composed of a urethane foam layer and a fabric which is attached to at least one main surface of the urethane foam layer. Generally, the automobile interior material of the present invention has a sandwich structure in which each sheet of fabric (totally two sheets) is attached to one of the two main surfaces of the urethane foam layer.

The urethane foam layer may be any rigid, semi-rigid or flexible urethane foam. Rigid urethane foam is preferred. The urethane foam layer is preferably thermoformable. The urethane foam layer preferably has open cells. The density of the urethane foam layer is generally from 20 kg/m³ to 100 kg/m³. The thickness of the urethane foam layer is generally from 2 mm to 1 cm.

The fabric is used as a reinforcing material for the automobile interior material. Examples of the fabric include a woven fabric and a knitted fabric. The fabric has such fine texture that a separation distance between theyarns (or between the fibers) is small. Preferably, the separation distance between an edge of oneyarn and an adjacent edge of a neighboryarn is at most 1 mm, more preferably, at most 0.5 mm, most preferably, it is at most 0.2 mm. The thickness of theyarn is generally from 0.1 mm to 1.0 mm. The thickness of the fabric is generally from 0.1 mm to 1.0 mm.

The material of the fabric is not limited, with the exception that it can not be glass. The fabric material may be a natural fiber (for example, a vegetable fiber such as cotton and hemp, and an animal fiber such as wool), a synthetic fiber (for example, polyester, polyamide and polyacryl) and/or a mixture thereof. The basis weight (a weight per a unit area) of the fabric may be, for example, from 50 g/m² to 300 g/m², preferably from 100 g/m² to 200 g/m². The fabric gives good reinforcement to the automobile interior material.

The fabric useful in the present invention is not limited to any specific type of material, fiber gauge, count ofyarns per unit length and the like. It is possible to use a backing of used clothes and/or a low-cost fabric used as in a futon bag, which has a performance equivalent to fabric made of glass.

The interior material of the present invention can be produced by immersing the fabric into an adhesive and adhering the fabric to a surface of the urethane foam. Examples of the adhesive include a urethane adhesive and an isocyanate adhesive. The amount of the adhesive may be from 20% by weight to 100% by weight, based on the basis weight of the fabric.

The interior material of the present invention effectively exhibits the effect of a sandwich structure so that the reinforcing effect caused by the reinforcing material is given.

The invention is further illustrated but is not intended to be limited by the following examples in which all parts and percentages are by weight unless otherwise specified.

### EXAMPLES

The present invention is illustrated by showing Examples hereinafter.

A molded sample in the following Examples was evaluated as follows:

(1) Flexural modulus

A flexural modulus was measured in accordance with JIS K 6301. A sample having a length of 150 mm and a width of 50 mm was cut from the molded sample. The measurement was conducted at a distance between supports of 100 mm and a test speed of 50 mm/min.

(2) Moldability

Moldability was evaluated by the rigidity at demolding, the degree of damage to surface skin for decoration and the like.

### Example 1

(1) A polymeric MDI (viscosity: about 100 mpa·s/25° C., NCO content: 31.5%, SBU ISOCYANATE 0357 manufactured by Sumika Bayer Urethane Co., Ltd.) was spray coated onto a fabric (a mixture woven fabric of polyester 65%/cotton 35%,yarn count: 45, basis weight: 110 g/m²) in an amount of 40 g/m².

(2) A 1% aqueous solution of bisdimethylaminoethyl ether was spray coated onto both sides of a thermoformable rigid urethane foam sheet having a unit area weight of 165 g/m² and open cells (length 33 cm×width 33 cm×thickness 5.5 mm) in an amount of 20 g/m².

(3) A sheet of the fabric produced in the step (1) was placed on each of the two sides of the rigid urethane sheet produced in the step (2), and pressurized in a mold having a test plate mold at 130° C. for 30 seconds to give a molded sample having a thickness of 5 mm.

This molded sample had such very light weight that a density (apparent density) was 0.10 g/cm³ and a unit area weight was 500 g/m², but a flexural modulus of the article was 2,200 kg/cm². The article had sufficient performance for the car headliner.

### Example 2

(1) A polymeric MDI (viscosity: about 100 mpa·s/25° C., NCO content: 31.5%, SBU ISOCYANATE 0357 manufactured by Sumika Bayer Urethane Co., Ltd.) was spray coated onto a fabric (a mixture woven fabric of polyester 65%/cotton 35%, yarn count: 45, basis weight: 110 g/m²) in an amount of 40 g/m².

(2) A 1% aqueous solution of bisdimethylaminoethyl ether was spray coated onto both sides of a thermoformable rigid urethane foam sheet having a unit area weight of 165 g/m² and open cells (length 33 cm×width 33 cm×thickness 5.5 mm) in an amount of 20 g/m².

(3) A sheet of the fabric produced in the step (1) was placed on each of the two sides of the rigid urethane sheet produced in the step (2), and pressurized in a mold having a deep drawing mold at 130° C. for 30 seconds to give a headliner-shaped sample having a thickness of 3 mm to 5 mm.

This headliner-shaped sample had sufficient rigidity at the time of demolding from the mold, had no unevenness on the surfaces, and had a sufficiently good appearance that the article could be used as a car headliner.

Since the fabric had a fine network structure, the fabric effectively adhered to the urethane foam core material on its whole surface via the adhesive to give excellent reinforcing effects. In addition, a drawn part does not usually have a crease. Even if a crease is caused, the crease does not appear on the surface due to thinness.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. An interior material for an automobile comprising:
a urethane foam layer, and
a fabric which is attached to at least one main surface of the urethane foam layer.

2. The interior material of claim 1 in which the fabric has a weight per a unit area of from 50 g/m² to 300 g/m².

3. The interior material of claim 1 in which the urethane foam layer is a thermoformable urethane foam having open cells and a density of from 20 kg/m³ to 100 kg/m³.

4. The interior material of claim 1 in which the fabric has such fine texture that its yarns are separated by a distance no greater than 1 mm.
